(19) United States
(12) Patent Application Publication
(10) Pub. No.: US 2023/0176356 A1
(43) Pub. Date: Jun. 8, 2023

(54) MICROSCOPE SYSTEM, PROJECTION UNIT, AND IMAGE PROJECTION METHOD

(71) Applicant: Evident Corporation, Nagano (JP)

(72) Inventor: Ayumu SAKURAI, Kamiina-gun (JP)

(73) Assignee: Evident Corporation, Nagano (JP)

(21) Appl. No.: 17/992,968

(22) Filed: Nov. 23, 2022

(30) Foreign Application Priority Data
Dec. 6, 2021 (JP) 2021-197518

(51) Int. Cl. G02B 21/36; G06T 3/40; G06T 7/00

(52) U.S. Cl. CPC G02B 21/367; G06T 3/40; G06T 7/0012; G02B 21/364; G06T 2207/10056

(57) ABSTRACT

A microscope system includes: a microscope optical system including an ocular lens, the microscope optical system being configured to form an optical image of a sample on an object side of the ocular lens; a processor configured to generate, based on examination information regarding examination to the sample and magnification information regarding a magnification of the microscope optical system, image data of a comparative image for comparison with the optical image; and a superimposition device configured to superimpose, based on the image data generated by the processor, the comparative image onto an image plane on which the optical image is formed.

### CROSS REFERENCE TO RELATED APPLICATIONS

This application is based upon and claims the benefit of priority from prior Japanese Patent Application No. 2021-197518, filed Dec. 6, 2021, the entire contents of which are incorporated herein by this reference.

### TECHNICAL FIELD

The disclosure of the present specification relates to a microscope system, a projection unit, and an image projection method.

### BACKGROUND

In the field of pathological diagnosis, color and shade information is extremely important. Thus, there are needs for diagnosis based on an optical image through an ocular lens. This is because digital images are generally inferior in color reproducibility and dynamic range to optical images.

However, in diagnosis through an ocular lens, a pathologist needs to move its eye away from the ocular lens every time the pathologist checks various types of reference information during diagnosis. Thus, the pathologist has difficulty in proceeding with diagnostic work efficiently. An exemplary technology related to solution of such a technical problem is described in JP H05-157974 A. A device including a transmissive liquid crystal element described in JP H05-157974 A displays a scale in the field of view, enabling simultaneous observation of an optical image and the scale.

### SUMMARY

According to one aspect of the present invention, provided is a microscope system including: a microscope optical system including an ocular lens, the microscope optical system being configured to form an optical image of a sample on an object side of the ocular lens; a processor configured to generate, based on examination information regarding examination to the sample and magnification information regarding a magnification of the microscope optical system, image data of a comparative image for comparison with the optical image; and a superimposition device configured to superimpose, based on the image data generated by the processor, the comparative image onto an image plane on which the optical image is formed.

According to one aspect of the present invention, provided is a projection unit for a microscope system including a microscope optical system, the projection unit including: a processor configured to generate, based on examination information regarding examination to a sample and magnification information regarding a magnification of the microscope optical system, image data of a comparative image for comparison with an optical image formed on an object side of an ocular lens included in the microscope optical system; and a superimposition unit configured to superimpose, based on the image data generated by the processor, the comparative image onto an image plane on which the optical image is formed.

According to one aspect of the present invention, provided is an image projection method to be performed by a microscope system including a microscope optical system, the image projection method including: forming an optical image of a sample on an object side of an ocular lens included in the microscope optical system; generating, based on examination information regarding examination to the sample and magnification information regarding a magnification of the microscope optical system, image data of a comparative image for comparison with the optical image; and superimposing, based on the image data generated, the comparative image onto an image plane on which the optical image is formed.

### BRIEF DESCRIPTION OF DRAWINGS

The present invention will be more apparent from the following detailed description when the accompanying drawings are referenced.

FIG. 1 illustrates an exemplary configuration of a microscope system according to a first embodiment;

FIG. 2 is a flowchart of exemplary image projection processing that the microscope system performs;

FIG. 3 is a flowchart of exemplary image data generation processing illustrated in FIG. 2;

FIG. 4 illustrates an exemplary configuration of a processing device;

FIG. 5 is a flowchart of other exemplary image projection processing that the microscope system performs;

FIG. 6 illustrates an exemplary image observed through an ocular lens in the microscope system;

FIG. 7 illustrates another exemplary image observed through the ocular lens in the microscope system;

FIG. 8 illustrates another exemplary image observed through the ocular lens in the microscope system;

FIG. 9 illustrates another exemplary image observed through the ocular lens in the microscope system;

FIG. 10 illustrates another exemplary image observed through the ocular lens in the microscope system;

FIG. 11 illustrates an exemplary configuration of a processing device;

FIG. 12 is a flowchart of exemplary image projection processing that a microscope system according to a second embodiment performs;

FIG. 13 illustrates an exemplary image observed through an ocular lens in the microscope system according to the second embodiment;

FIG. 14 illustrates an exemplary configuration of a microscope system according to a third embodiment;

FIG. 15 illustrates an exemplary configuration of a processing device;

FIG. 16 illustrates an exemplary configuration of a processing device;

FIG. 17 is a flowchart of exemplary image projection processing that the microscope system according to the third embodiment performs;

FIG. 18 illustrates an exemplary configuration of a processing device;

FIG. 19 illustrates an exemplary configuration of a processing device;

FIG. 20 is a flowchart of exemplary image projection processing that a microscope system according to a fourth embodiment performs;

FIG. 21 illustrates an exemplary configuration of a processing device;

FIG. 22 illustrates an exemplary configuration of a processing device;

FIG. 23 is a flowchart of exemplary image projection processing that a microscope system according to a fifth embodiment performs;

FIG. 24 illustrates an exemplary image observed through an ocular lens in the microscope system according to the fifth embodiment;

FIG. 25 illustrates an exemplary configuration of a microscope system according to a sixth embodiment;

FIG. 26 illustrates an exemplary configuration of a processing device;

FIG. 27 illustrates an exemplary configuration of a processing device;

FIG. 28 is a flowchart of exemplary image projection processing that the microscope system according to the sixth embodiment performs;

FIG. 29 illustrates an exemplary configuration of a microscope system according to a seventh embodiment; and

FIG. 30 illustrates an exemplary hardware configuration of a computer for achievement of a processing device.

### DESCRIPTION OF EMBODIMENTS

In many cases, length and size are important elements for judgment in pathological diagnosis. However, simply displaying a scale in the field of view is not necessarily sufficient for support to a pathologist. This is because length and size as criteria for judgment vary depending on the type or progression of a disease to be diagnosed. Therefore, even with a scale displayed, for acquisition of information as criteria for judgment during diagnosis, the pathologist needs to move its eye away from the ocular lens.

The technical problem has been described above with pathological diagnosis as an example. However, a similar technical problem is likely to occur in examination including various types of diagnosis requiring human judgment. In consideration of such circumstances as above, embodiments of the present invention will be described.

### First Embodiment

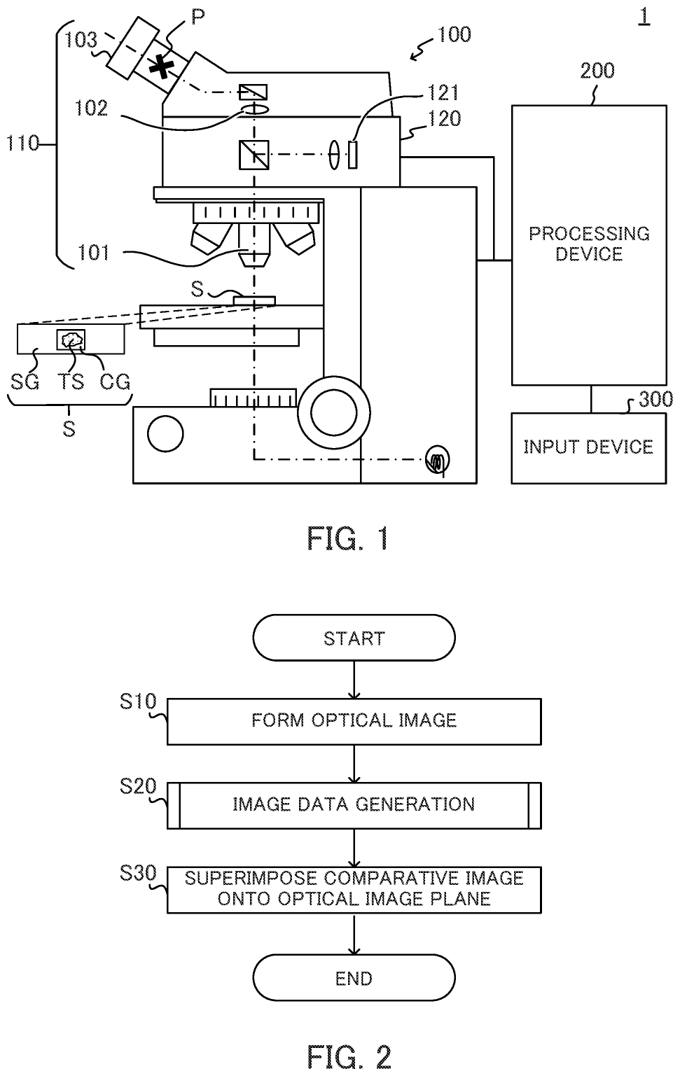

FIG. 1 illustrates an exemplary configuration of a microscope system 1 according to the present embodiment. The microscope system 1 serves as a microscope system to be used by a pathologist for pathological diagnosis. The microscope system 1 includes at least a microscope optical system 110 including an ocular lens 103, a processing device 200, and a projection unit 120.

In the microscope system 1, the processing device 200 generates image data of a comparative image to be compared by the pathologist with an image of a sample S (optical image P) in pathological diagnosis. Furthermore, based on the image data generated by the processing device 200, the projection unit 120 superimposes the comparative image onto the image plane on which the optical image P is formed by the microscope optical system 110. Thus, the pathologist who observes the sample S through the ocular lens 103 can view an image in which information (comparative image) to be compared with the sample S during pathological diagnosis is superimposed on the optical image P. Thus, the microscope system 1 enables the pathologist to proceed with diagnosis work efficiently with a reduction in the number of times the pathologist moves its eye away from the ocular lens 103 during diagnosis.

Furthermore, in the microscope system 1, the processing device 200 generates image data of a comparative image, based on examination information regarding examination to the sample S and magnification information regarding the magnification of the microscope optical system 110. The examination information regarding examination to the sample S corresponds typically to disease information specifying a disease to be diagnosed in pathological diagnosis with the sample S. For example, in a case where the pathologist observes the sample S to diagnose large bowel cancer, “large bowel cancer” that is a disease name (type of disease) is exemplary examination information. In a case where the pathologist further diagnoses the progression of the disease, the examination information may include information regarding progression. Thus, “large bowel cancer at stage 2” that is a combination of the disease name and progression is exemplary examination information.

The processing device 200 generates image data of a comparative image, based on the examination information, leading to provision of information corresponding to the purpose of examination (purpose of diagnosis) (comparative image) to the pathologist. Thus, technical support can be given to the pathologist in diagnosis. Furthermore, taking into account the magnification information in addition to the examination information enables superimposition of the comparative image having a proper size to the optical image P on the optical image plane. For example, a change in the magnification of an objective lens 101, such as a 10-fold magnification and a 40-fold magnification, enables a change in the size of the comparative image projected on the image plane. As already described above, size is extremely important information in pathological diagnosis. Provision of a proper size of information to be compared with the sample S enables further support to the pathologist in diagnosis.

The configuration of the microscope system 1 will be described in more detail below with reference to FIG. 1. As illustrated in FIG. 1, the microscope system 1 includes a microscope 100 and an input device 300 in addition to the processing device 200.

For example, the microscope 100 serves as an upright microscope but may be an inverted microscope. The microscope 100 includes the microscope optical system 110 including the objective lens 101, a tube lens 102, and the ocular lens 103. The microscope optical system 110 forms the optical image P of the sample S on the object side of the ocular lens 103, with the objective lens 101 and the tube lens 102. The microscope 100 enables the pathologist to observe the optical image P of the sample S through the ocular lens 103. Thus, the pathologist can enjoy the advantage of visual observation.

As illustrated in FIG. 1, for example, the sample S is a prepared sample (slide sample) including a slide glass SG and a cover glass CG between which a test sample TS is sandwiched and fixed. Note that the sample S is not limited to such a slide sample and thus may be a sample housed in a different container, such as a well plate or a dish.

The microscope 100 further includes the projection unit 120 between an ocular barrel including the ocular lens 103 and a microscope body to which the objective lens 101 is fixed. The projection unit 120 is an exemplary superimposition device that superimposes the comparative image onto the optical image plane. In this example, the projection unit 120 serves as an intermediate barrel that acts on an infinity beam output from the microscope body. The projection unit 120 may be detachable from the microscope 100.

The projection unit 120 includes a projection device 121. Due to light emission of the projection device 121, the projection unit 120 projects the comparative image onto the optical image plane. The projection device 121 is, for example, a liquid crystal device or a digital micromirror device, and controls its light emission, based on the image data generated by the processing device 200. The projection unit 120 further includes an optical deflection element, such as a half mirror, and a lens, for guiding light from the projection device 121 to an observation optical path leading to the ocular lens 103.

For example, the processing device 200 serves as a control box that controls the microscope 100. The processing device 200 generates such a comparative image as described above in response to execution of a predetermined program by a processing circuit included in the processing device 200 and then outputs the comparative image to the projection unit 120.

The input device 300 serves as a device to be operated by a pathologist as a user of the microscope system 1, and is connected to the processing device 200. The input device 300 may include, for example, a keyboard, a mouse, a joystick, and a touch panel.

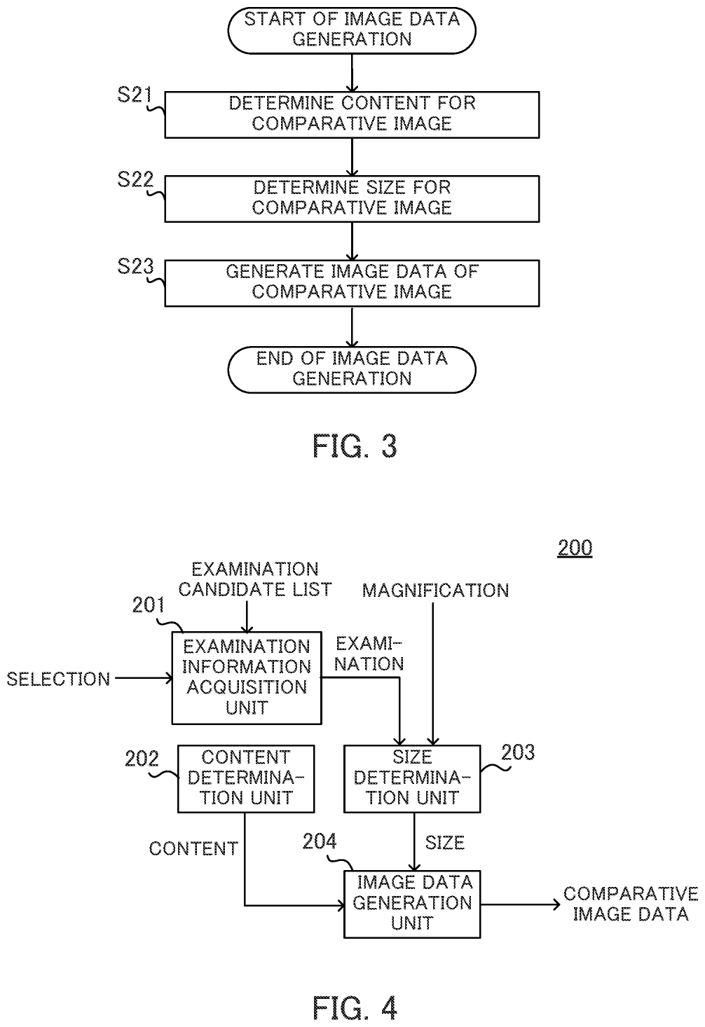

The microscope system 1 having such a configuration as above performs image projection processing illustrated in FIGS. 2 and 3. FIG. 2 is a flowchart of exemplary image projection processing that the microscope system 1 performs. FIG. 3 is a flowchart of exemplary image data generation processing illustrated in FIG. 2. An image projection method that the microscope system 1 performs will be described below with reference to FIGS. 2 and 3.

First, the microscope system 1 forms the optical image P of the sample S (step S10). In this step, the tube lens 102 condenses, on the image plane, light from the sample S taken in by the objective lens 101, so that the microscope optical system 110 forms the optical image P of the sample S on the object side of the ocular lens 103.

Next, the microscope system 1 generates image data of a comparative image (step S20). In this step, the processing device 200 executes a predetermined program to perform the image data generation processing illustrated in FIG. 3. Specifically, first, the processing device 200 determines suitable content for comparison with the optical image P as content for the comparative image (step S21), and determines a suitable size for comparison with the optical image P as a size for the comparative image (step S22). After that, the processing device 200 generates image data of the comparative image, in accordance with the content and size determined in steps S21 and S22 (step S23). The generated image data is output to the projection unit 120.

Finally, the microscope system 1 superimposes the comparative image onto the optical image plane (step S30). In this step, due to control of light emission of the projection device 121 based on the image data, light emitted from the projection device 121 forms an image on the optical image plane, resulting in formation of the comparative image. Thus, the comparative image is superimposed on the optical image P.

In the microscope system 1, the comparative image generated by the processing device 200 is visually observed together with the optical image of the sample S through the ocular lens 103. Thus, the pathologist can diagnose efficiently while comparing the comparative image and the optical image without moving its eye away from the ocular lens 103 during pathological diagnosis based on the optical image of the sample S. The comparative image of which the content and size are suitable to diagnosis is projected, enabling facilitation of comparative work.

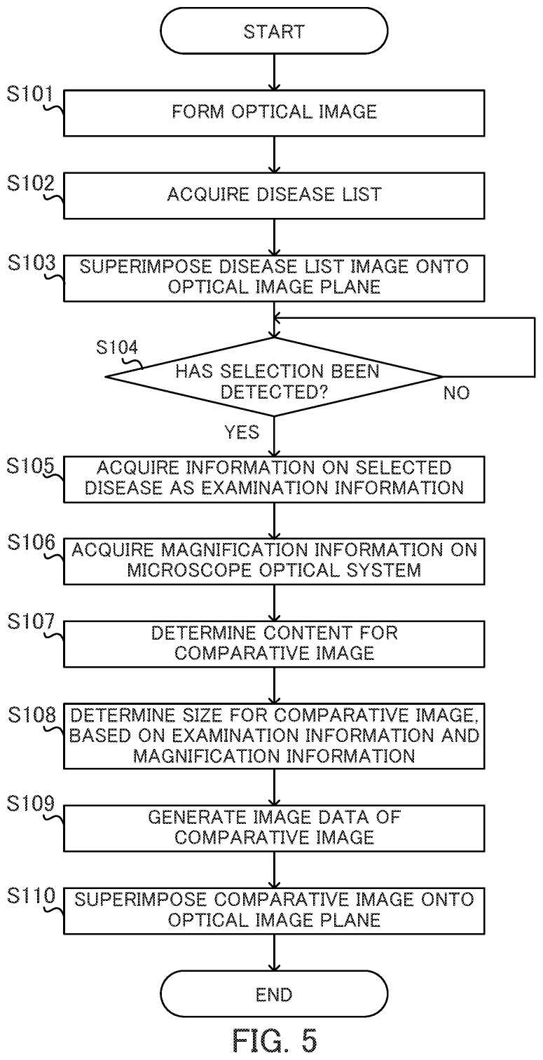

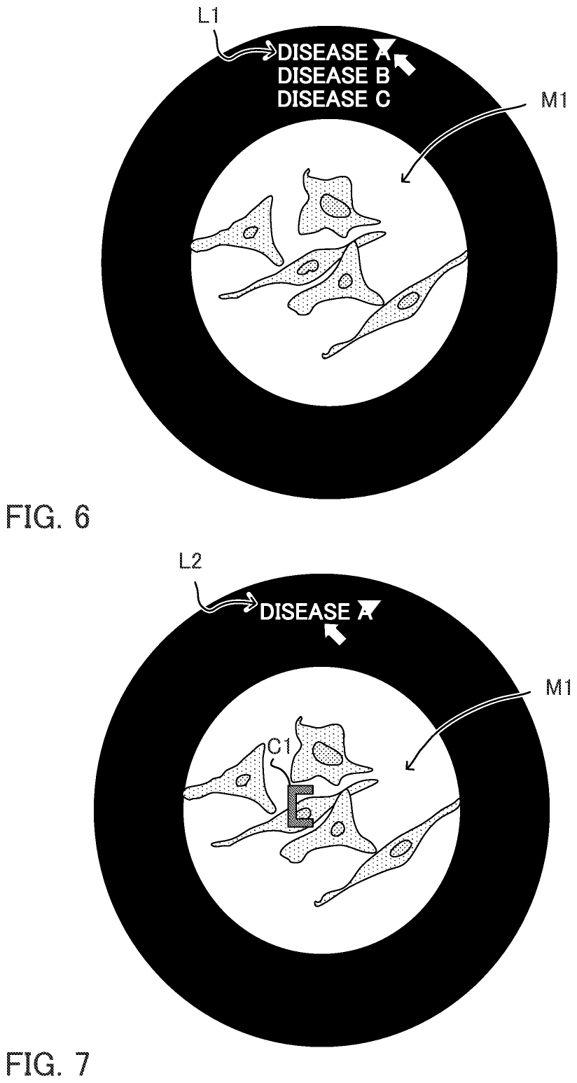

FIG. 4 illustrates an exemplary configuration of the processing device 200. FIG. 5 is a flowchart of other exemplary image projection processing that the microscope system 1 performs. FIGS. 6 to 9 each illustrate an exemplary image observed through the ocular lens 103 in the microscope system 1. A specific exemplary image projection method that the microscope system 1 performs will be described in detail below with reference to FIGS. 4 to 9.

The configuration of the processing device 200 will be described. As illustrated in FIG. 4, the processing device 200 includes an examination information acquisition unit 201, a content determination unit 202, a size determination unit 203, and an image data generation unit 204. For example, in response to execution of a program in the processing device 200, an electric circuit included in the processing device 200 operates as the units.

The examination information acquisition unit 201 acquires examination information. The examination information includes disease information specifying a disease to be diagnosed in pathological diagnosis with the sample S. In this example, the disease information corresponds to the name of the disease. The examination information acquisition unit 201 receives, as an input, an examination candidate list and a selection by a user and then outputs the examination information to the size determination unit 203.

The content determination unit 202 determines content for a comparative image. The content for the comparative image includes an indicator indicating the size of a noticed part related to the disease. The noticed part is, for example, a lesion part. The content determination unit 202 determines an image in a previously determined shape indicating the size of a noticed part as content for the comparative image and then outputs the content to the image data generation unit 204. The previously determined shape may be, but is not particularly limited to, for example, a U shape, an arrow, or a straight line.

The size determination unit 203 determines a size for the comparative image. The size determination unit 203 determines a size for the comparative image, based on the examination information (disease information) output from the examination information acquisition unit 201 and magnification information regarding the magnification of the microscope optical system 110, and then outputs the size to the image data generation unit 204.

Note that, desirably, the size determination unit 203 determines a size directly comparable with the optical image P as a size for the comparative image. In diagnosis based on a criterion, such as which layer a cancer cell has reached or how deep a cancer cell has reached, desirably, the comparative image enables verification of the size on the optical image plane at the depth as the diagnosis criterion. Thus, desirably, the size determination unit 203 specifies, based on the examination information, the depth as the diagnosis criterion and specifies, based on the magnification information, the length on the optical image plane corresponding to the depth, to determine a size for the comparative image.

The image data generation unit 204 generates image data of the comparative image. Based on the content for the comparative image output from the content determination unit 202 and the size for the comparative image output from the size determination unit 203, the image data generation unit 204 generates image data of the comparative image and then outputs the image data to the projection unit 120.

In response to starting of the image projection processing illustrated in FIG. 5, the microscope system 1 forms an optical image (step S101). The processing in step S101 is performed by the microscope 100. Note that the processing in step S101 is similar to the processing in step S10 illustrated in FIG. 2.

Furthermore, the microscope system 1 acquires a disease list (step S102). In this step, the processing device 200 (examination information acquisition unit 201) acquires the disease list, in which a plurality of pieces of disease information is listed, from a storage device included in the processing device 200. The disease list includes, for example, “disease A”, “disease B”, and “disease C”.

The microscope system 1 superimposes a disease list image onto the optical image plane (step S103). In this step, based on the disease list acquired in step S102, the processing device 200 generates image data of an image (disease list image) including a plurality of names of diseases listed, and then outputs the image data to the projection unit 120. Based on the image data, the projection unit 120 superimposes the disease list image onto the optical image plane. Thus, the image illustrated in FIG. 6 is observed through the ocular lens 103. Referring to FIG. 6, an optical image M1 corresponds to the optical image P described above, and a list image L1 corresponds to the disease list image described above.

After that, the pathologist operates the input device 300 to select a particular disease from the plurality of diseases in the list image L1 (in other words, the plurality of examination candidates). Then, in the microscope system 1, the processing device 200 (examination information acquisition unit 201) detects the selection (YES in step S104) and acquires information on the selected disease (examination candidate) as examination information (step S105).

The microscope system 1 acquires magnification information on the microscope optical system 110 (step S106). In this step, the processing device 200 may acquire the magnification information manually input by the pathologist through the input device 300 or may acquire the magnification information, based on identification information given to the microscope optical system 110, read by the microscope 100. Note that the magnification information may be any information enabling specification of the magnification of projection of the optical image P. The magnification information may be the magnification itself or may be information, such as the focal length, that can be converted to the magnification based on known information.

In response to acquisition of the examination information and the magnification information, the microscope system 1 determines content and a size for a comparative image (step S107 and step S108). In step S107, the processing device 200 (content determination unit 202) determines an image in a shape indicating the size of a noticed part related to the disease (e.g., a U-shaped image) as content for the comparative image.

In step S108, the processing device 200 (size determination unit 203) determines a size for the comparative image, based on the examination information and the magnification information. More specifically, the processing device 200 specifies the disease to be diagnosed from the examination information, to specify a criterial length related to the disease. Then, the processing device 200 determines a size for the comparative image such that the length is enlarged by the magnification of the optical image on the optical image plane. For example, in diagnosis of large bowel cancer, the degree of infiltration to the submucosa (SM infiltration distance) is often used as a base for judgment. In a case where large bowel cancer is specified in the examination information, the processing device 200 may specify an infiltration distance (μm) as a criterion for judgment and then determine a size for the comparative image, based on the specified infiltration distance.

Note that, at the time of determination of a length as a criterion for judgment, such as an infiltration distance, based on the examination information, the processing device 200 may refer to reference criteria information prepared in advance. Specific exemplary reference criteria information is a diagnosis guideline for various types of diseases. The processing device 200 may, in advance, store a length as a criterion for judgment per disease extracted from the diagnosis guideline, in association with the corresponding disease, and may determine a length as a criterion for judgment, based on the examination information, with reference to the associated information.

In accordance with the determined content and size, the microscope system 1 generates image data of the comparative image (step S109). In this step, the processing device 200 (image data generation unit 204) generates image data of the comparative image having the content determined in step S107 and the size determined in step S108, and then outputs the image data to the projection unit 120.

Finally, the microscope system 1 superimposes the comparative image onto the optical image plane (step S110). In this step, based on the image data output from the processing device 200, the projection unit 120 projects the comparative image onto the optical image plane. Thus, the image illustrated in FIG. 7 is observed through the ocular lens 103.

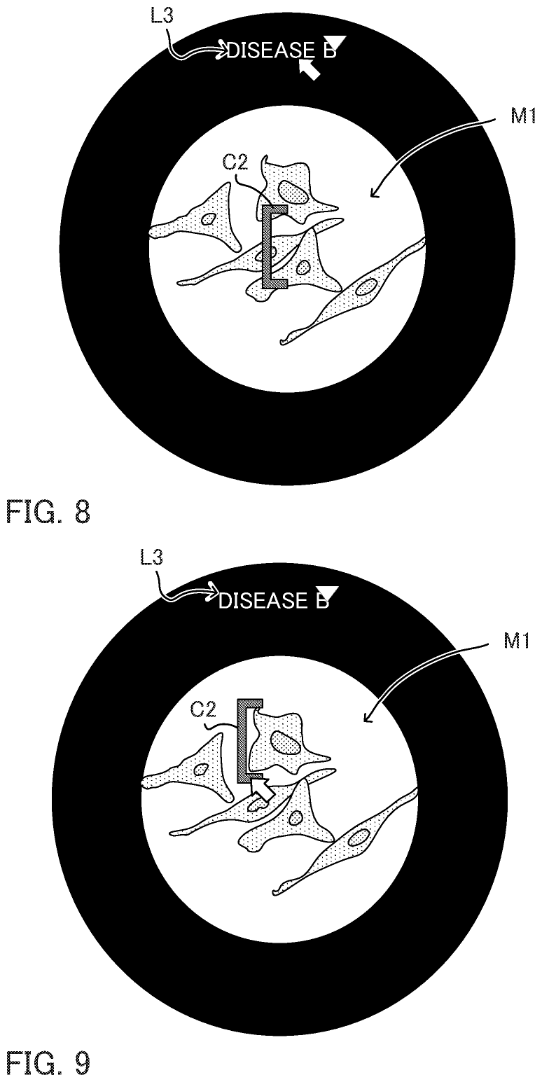

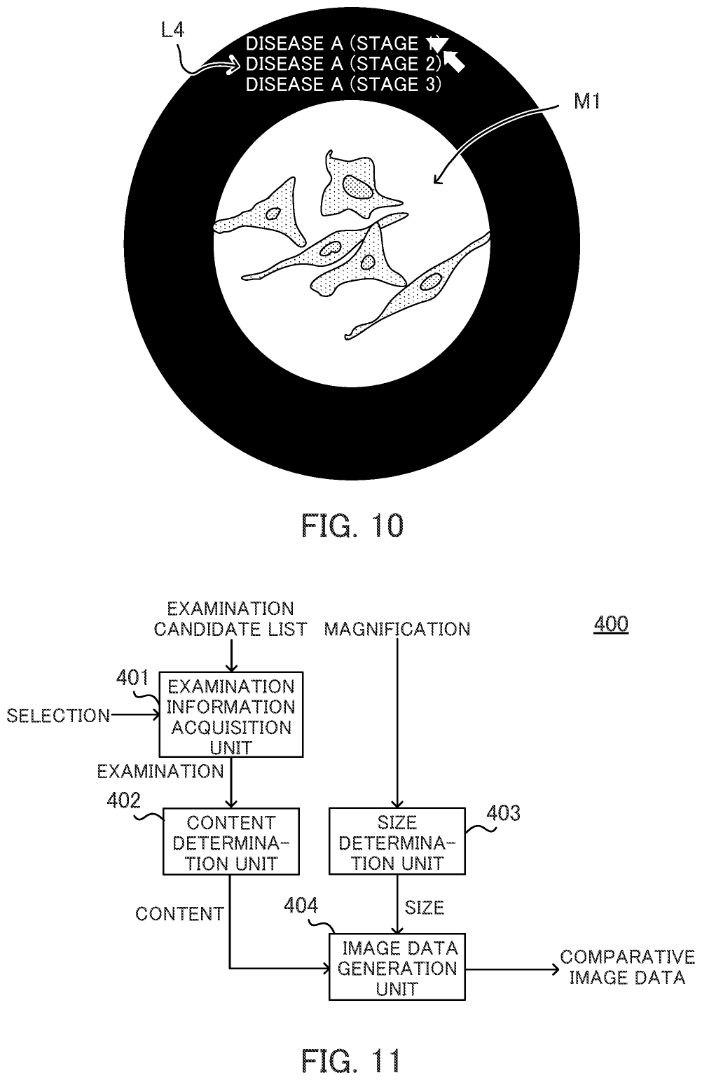

Referring to FIG. 7, a list image L2 indicates the disease A selected by the pathologist, detected in step S104. A comparative image C1 corresponds to an image, indicating size, to be compared with the optical image M1 (U-shaped image) and indicates a criterial length related to the disease A selected by the pathologist. For example, as illustrated in FIG. 8, selection of a different disease by the pathologist causes a comparative image C2 corresponding to a criterial length related to the disease B indicated by a list image L3, to be projected on the image plane. The pathologist compares the comparative image C2 with the noticed part in the optical image M1, leading to, for example, diagnosis of whether the patient from which the sample S has been extracted has contracted the disease B. Thus, for facilitation of comparison with the noticed part, as illustrated in FIG. 9, desirably, the comparative image C2 is projected at any position in the field of view in response to an operation from the pathologist to the input device 300.

Note that the example in which the list image is projected out of the region in which the optical image M1 is projected has been given, but the list image may be projected in superimposition on the optical image M1. The disease information is exemplarily provided as the examination information, but the examination information may include, in addition to the disease information, progression information specifying the progression of the disease. The progression is, for example, stage (disease stage). In a case where the examination information includes the progression information, as illustrated in FIG. 10, a list image L4 projected on the image plane may be an image listing combinations each including the name and progression of a disease. In accordance with the combination selected by the pathologist, the processing device 200 (size determination unit 203) may determine a size for the comparative image, based on the disease information, the progression information, and the magnification information. As a result, the comparative image having a criterial length related to the disease having the progression in the selected combination may be projected together with the optical image M1 onto the image plane.

The microscope system 1 and the image projection method according to the present embodiment enable support to pathological diagnosis with visual observation based on an optical image, so that a reduction can be made in the work burden of the pathologist.

### Second Embodiment

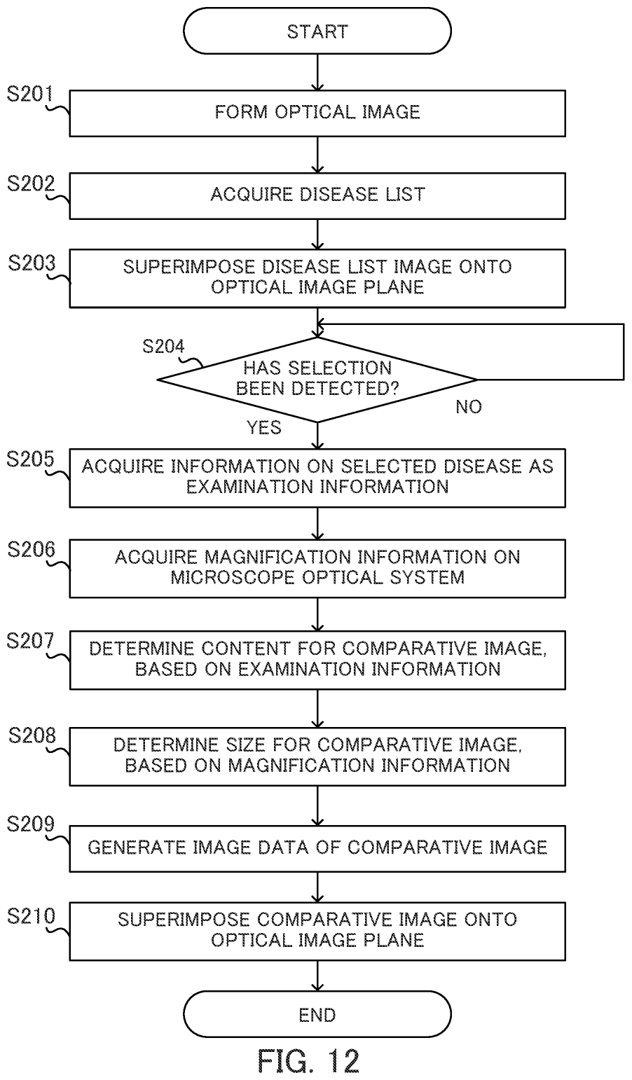

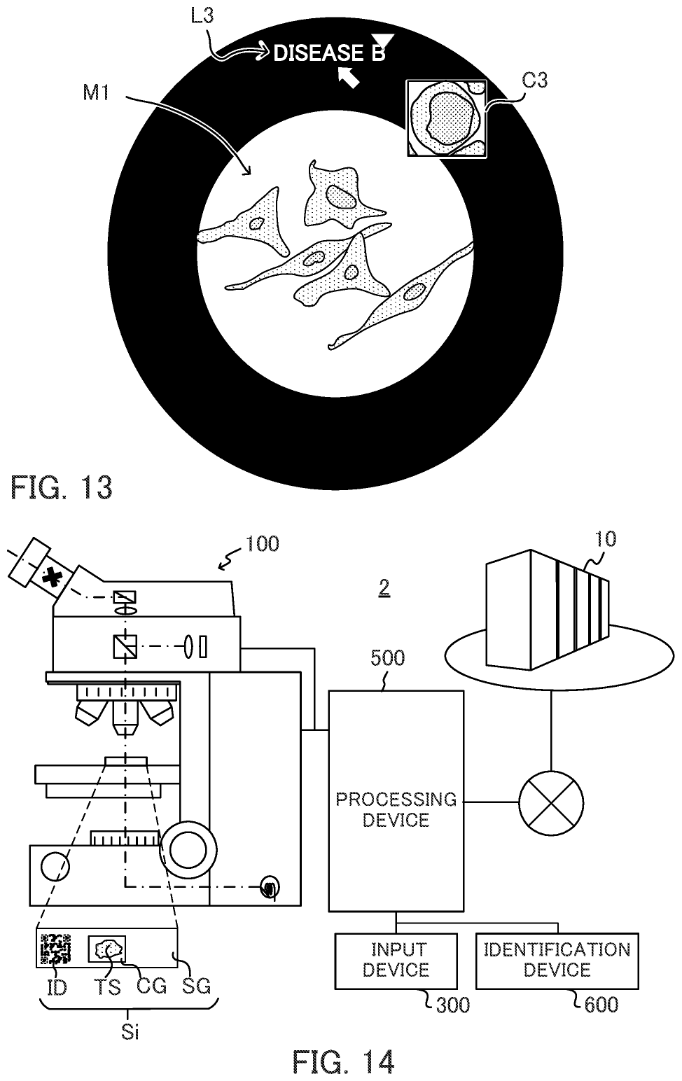

FIG. 11 illustrates an exemplary configuration of a processing device 400. FIG. 12 is a flowchart of exemplary image projection processing that a microscope system according to the present embodiment performs. FIG. 13 illustrates an exemplary image observed through an ocular lens 103 in the microscope system according to the present embodiment. A specific exemplary image projection method that the microscope system according to the present embodiment performs will be described in detail below with reference to FIGS. 11 to 13.

Note that the microscope system according to the present embodiment is different from the microscope system 1 in that the processing device 400 is provided instead of a processing device 200. As illustrated in FIG. 11, the processing device 400 includes an examination information acquisition unit 401, a content determination unit 402, a size determination unit 403, and an image data generation unit 404. For example, in response to execution of a program in the processing device 400, an electric circuit included in the processing device 400 operates as the units.

The examination information acquisition unit 401 acquires examination information. The examination information acquisition unit 401 is different from the examination information acquisition unit 201 of the processing device 200 according to the first embodiment in terms of outputting the acquired examination information to the content determination unit 402.

The content determination unit 402 determines content for a comparative image. More specifically, based on the examination information (disease information) output from the examination information acquisition unit 401, the content determination unit 402 determines content for the comparative image and then outputs the content to the image data generation unit 404. The content for the comparative image includes an image of a noticed part related to the disease specified by the examination information. The noticed part is, for example, a lesion part. That is, the content determination unit 402 determines, from images of lesion parts of a plurality of diseases stored in advance, the image of a lesion part of the disease specified by the examination information, as content for the comparative image.

The size determination unit 403 determines a size for the comparative image. More specifically, based on magnification information regarding the magnification of a microscope optical system 110, the size determination unit 403 determines a size for the comparative image and then outputs the size to the image data generation unit 404. For example, based on the magnification of the microscope optical system 110 indicated by the magnification information and the magnification of an image of a lesion part stored in advance, the size determination unit 403 may calculate the magnification of image conversion and determine, based on the calculated magnification, a size for the comparative image.

The image data generation unit 404 generates image data of the comparative image. The image data generation unit 404 is similar in operation to the image data generation unit 404 of the processing device 200 according to the first embodiment, and outputs the generated image data to a projection unit 120.

Steps S201 to S206 in the image projection processing illustrated in FIG. 12 are similar to steps S101 to S106 in the image projection processing illustrated in FIG. 5.

In response to acquisition of examination information and magnification information, the microscope system determines content and a size for a comparative image (step S207 and step S208). In step S207, the processing device 400 (content determination unit 402) determines content for the comparative image, based on the examination information. More specifically, the processing device 400 determines, from the images of lesion parts of the plurality of diseases stored in advance in the processing device 400, the image of a noticed part related to the disease specified by the examination information (e.g., the image of a cancer cell) as content for the comparative image. Then, the processing device 400 reads the image and then outputs the image to the image data generation unit 404.

In step S208, based on the magnification information, the processing device 400 (size determination unit 403) determines a size for the comparative image. More specifically, for example, in a case where the magnification of the optical image is 40, the processing device 400 determines a magnification of 40 for the comparative image and then outputs the information to the image data generation unit 404.

In accordance with the determined content and size, the microscope system generates image data of the comparative image (step S209). In this step, the processing device 400 (image data generation unit 404) enlarges or reduces the image output from the content determination unit 402 in step S207, based on the information output from the size determination unit 403 in step S208, to generate image data of the comparative image. The generated image data is output to the projection unit 120.

Finally, the microscope system superimposes the comparative image onto the optical image plane (step S210). In this step, based on the image data output from the processing device 400, the projection unit 120 projects the comparative image onto the optical image plane. Thus, the image illustrated in FIG. 13 is observed through the ocular lens 103.

Referring to FIG. 13, a comparative image C3 corresponds to an image of a lesion part of a disease B indicated by a list image L3, and is identical in magnification to an optical image M1. Thus, for example, the pathologist compares the lesion indicated by the comparative image C3 with the noticed part in the optical image M1, leading to diagnosis of whether the patient from which the sample S has been extracted has contracted the disease B. Note that, similarly to the comparative image C2, desirably, the comparative image C3 is projected at any position in the field of view in response to an operation from the pathologist to an input device 300.

Similarly to the first embodiment, the microscope system and the image projection method according to the present embodiment enable support to pathological diagnosis with visual observation based on an optical image, so that a reduction can be made in the work burden of the pathologist.

### Third Embodiment

FIG. 14 illustrates an exemplary configuration of a microscope system 2 according to the present embodiment. The microscope system 2 according to the present embodiment is different from the microscope system 1 in terms of including a processing device 500, instead of a processing device 200, and an identification device 600, the processing device 500 being connected to an external system 10. A sample Si for use in the microscope system 2 according to the present embodiment is different from a sample S in terms of the sample Si (slide glass SG) given identification information ID.

The identification device 600 serves as an identification information reader that reads the identification information given to the sample Si. The identification information is, for example, a unidimensional or two-dimensional code. Note that the identification information may be character information handwritten or printed. In this case, the identification device 600 may include an image capturing device and may read the identification information, by character recognition, from an image acquired by the image capturing device.

For example, the external system 10 serves as a system that manages information regarding samples input by sample makers (sample information) and information regarding patients input by clinicians (patient information). Hereinafter, the sample information and patient information managed by the external system 10 are referred to as supplementary information. Note that the supplementary information may indicate only the sample information, indicate only the patient information, or indicate both the sample information and the patient information.

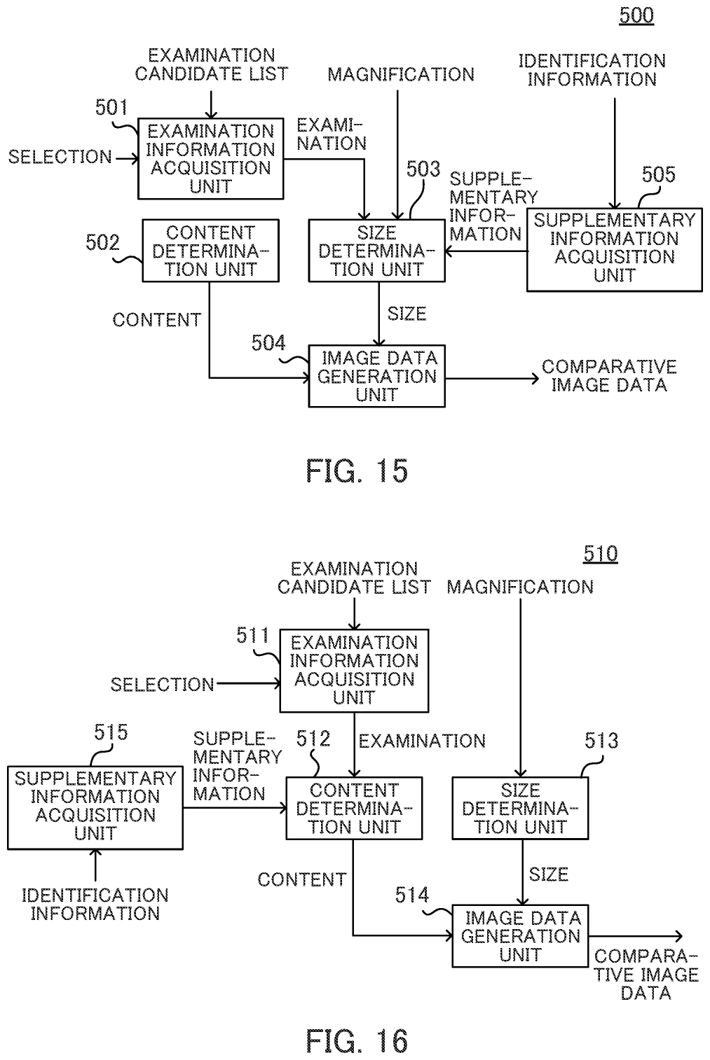

FIG. 15 illustrates an exemplary configuration of the processing device 500. The processing device 500 includes an examination information acquisition unit 501, a content determination unit 502, a size determination unit 503, an image data generation unit 504, and a supplementary information acquisition unit 505. For example, in response to execution of a program in the processing device 500, an electric circuit included in the processing device 500 operates as the units.

The processing device 500 can be regarded as a modification of the processing device 200 according to the first embodiment. The processing device 500 is different from the processing device 200 according to the first embodiment in that the supplementary information acquisition unit 505 is provided and the size determination unit 503 determines a size for a comparative image, based on the supplementary information. The examination information acquisition unit 501, the content determination unit 502, and the image data generation unit 504 are similar to the examination information acquisition unit 201, the content determination unit 202, and the image data generation unit 204, respectively.

Based on the identification information ID read by the identification device 600 from the sample Si, the supplementary information acquisition unit 505 acquires supplementary information from the external system 10 and then outputs the supplementary information to the size determination unit 503. Note that the supplementary information managed by the external system 10 is associated with the identification information ID in advance. Thus, based on the identification information, the supplementary information acquisition unit 505 can acquire sample information regarding the sample Si (test sample TS) and patient information regarding the patient from which the sample Si (test sample TS) has been extracted.

The sample information may include, but is not particularly limited to, material (e.g., the type of a cell or tissue and the site of extraction of a cell or tissue), staining (e.g., the presence or absence of staining and a staining method), and other information (a preparing method). The patient information may include, but is not particularly limited to, patient name, gender, age, past history, and others (menstrual cycle and last menses).

The size determination unit 503 determines a size for a comparative image. More specifically, based on examination information, magnification information, and the supplementary information, the size determination unit 503 determines a size for the comparative image and then outputs the size to the image data generation unit 504. The size determination unit 503 is different from the size determination unit 203 in that account is taken of the supplementary information in addition to the examination information and the magnification information. Thus, even in a case where the diagnosis criterion varies depending on the gender or age of the patient included in the supplementary information, a proper size can be determined for the comparative image.

Note that the image data generation unit 504 is similar in operation to the image data generation unit 204. However, the content and size for the comparative image to be input to the image data generation unit 504 are derived from the examination information, the magnification information, and the supplementary information. Therefore, unlike the image data generation unit 204, the image data generation unit 504 generates image data, based on the examination information, the magnification information, and the supplementary information.

The microscope system 2 may include a processing device 510 illustrated in FIG. 16 instead of the processing device 500. The processing device 510 can be regarded as a modification of the processing device 400 according to the second embodiment. The processing device 510 is different from the processing device 400 in that a supplementary information acquisition unit 515 is provided and a content determination unit 512 determines content for a comparative image, based on supplementary information. An examination information acquisition unit 511, a size determination unit 513, and an image data generation unit 514 are similar to the examination information acquisition unit 401, the size determination unit 403, and the image data generation unit 404, respectively.

Based on the identification information ID read by the identification device 600 from the sample Si, the supplementary information acquisition unit 515 acquires supplementary information from the external system 10 and then outputs the supplementary information to the content determination unit 512. The content determination unit 512 determines content for a comparative image. More specifically, based on examination information and the supplementary information, the content determination unit 512 determines content for the comparative image and then outputs the content to the image data generation unit 514. The content determination unit 512 is different from the content determination unit 402 in that account is taken of the supplementary information in addition to the examination information. Thus, even in a case where the form of a lesion part varies depending on the gender or age of the patient included in the supplementary information, proper content can be determined for the comparative image.

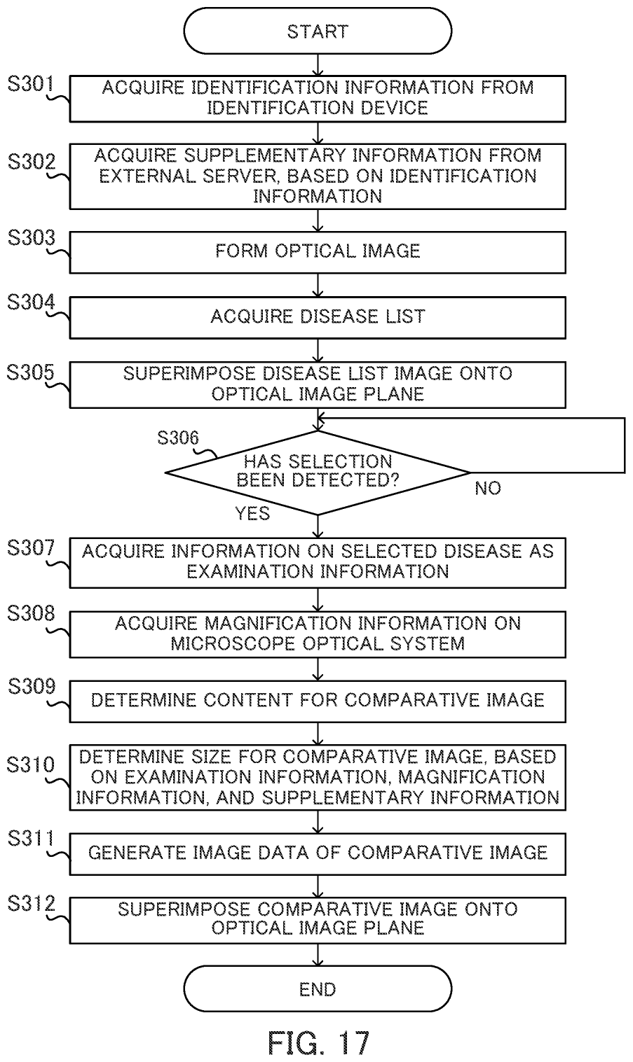

FIG. 17 is a flowchart of exemplary image projection processing that the microscope system 2 according to the present embodiment performs. A specific exemplary image projection method that the microscope system 2 performs will be described in detail below with reference to FIG. 17.

In response to starting of the image projection processing illustrated in FIG. 17, the microscope system 2 acquires identification information from the identification device 600 (step S301) and then acquires supplementary information from the external system 10, based on the acquired identification information (step S302). The supplementary information includes at least either sample information regarding the sample Si or patient information regarding the patient from which the sample Si has been extracted. The processing in steps S303 to S309 following step S302 is similar to the processing in steps S101 to S107 in the image projection processing illustrated in FIG. 5.

In response to determination of content for a comparative image, the microscope system 2 further determines a size for the comparative image (step S310). In step S310, based on examination information, magnification information, and the supplementary information, the processing device 500 (size determination unit 503) determines a size for the comparative image and then outputs the information to the image data generation unit 404. The processing in steps S311 and S312 following the step S310 is similar to the processing in steps S109 and S110 in the image projection processing illustrated in FIG. 5.

Similarly to the first embodiment, the microscope system and the image projection method according to the present embodiment enable support to pathological diagnosis with visual observation based on an optical image, so that a reduction can be made in the work burden of the pathologist. Furthermore, according to the present embodiment, the pathologist can diagnose with the comparative image, created based on information related to the patient (patient information and sample information), suitable for diagnosis of the patient.

### Fourth Embodiment

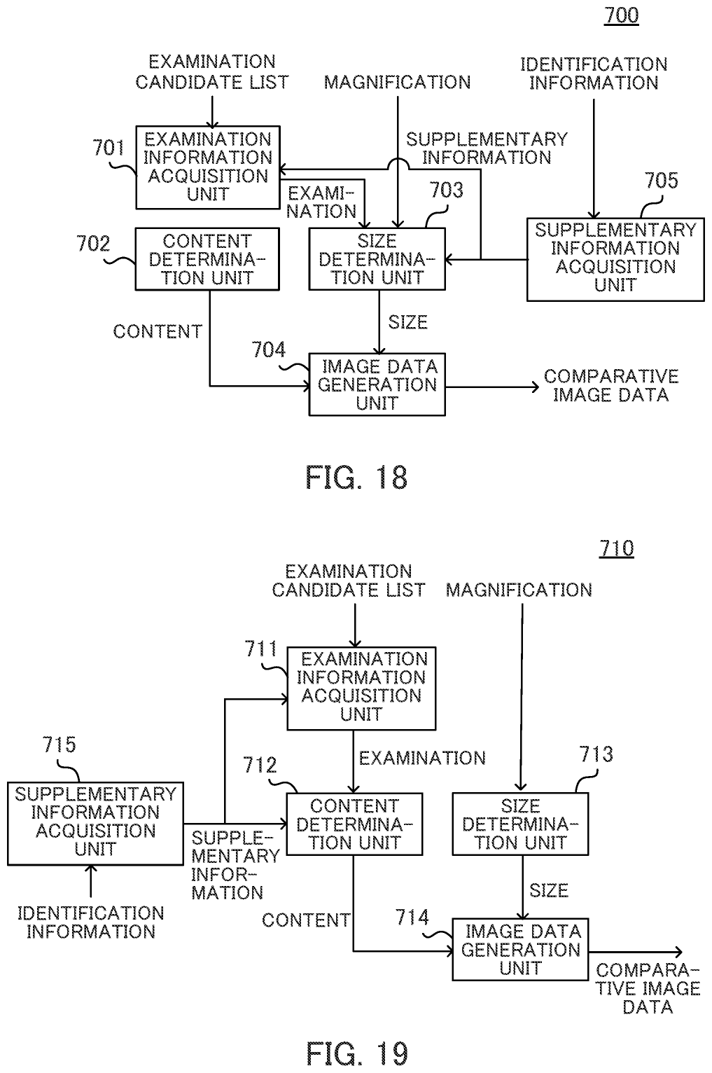

FIG. 18 illustrates an exemplary configuration of a processing device 700. A microscope system according to the present embodiment is different from the microscope system 2 in terms of including the processing device 700 instead of a processing device 500. As illustrated in FIG. 18, the processing device 700 includes an examination information acquisition unit 701, a content determination unit 702, a size determination unit 703, an image data generation unit 704, and a supplementary information acquisition unit 705. For example, in response to execution of a program in the processing device 700, an electric circuit included in the processing device 700 operates as the units.

The processing device 700 can be regarded as a modification of the processing device 500 according to the third embodiment. The processing device 700 is different from the processing device 500 according to the third embodiment in that the supplementary information acquisition unit 705 outputs supplementary information to the examination information acquisition unit 701 and the examination information acquisition unit 701 acquires examination information without an operation of selection from a pathologist. The content determination unit 702, the size determination unit 703, and the image data generation unit 704 are similar to the content determination unit 502, the size determination unit 503, and the image data generation unit 504, respectively.

The examination information acquisition unit 701 acquires examination information. The examination information acquisition unit 701 is different from the examination information acquisition unit 501 of the processing device 500 in terms of acquiring, as examination information, information on an examination candidate selected, based on supplementary information acquired by the supplementary information acquisition unit 705, from a plurality of examination candidates included in an examination candidate list. For example, in a case where the supplementary information includes information on the site of extraction of a sample Si (e.g., the large bowel), based on the information, the examination information acquisition unit 701 may select and acquire, as examination information, a particular disease (e.g., large bowel cancer) from the plurality of examination candidates.

The microscope system according to the present embodiment may include a processing device 710 illustrated in FIG. 19 instead of the processing device 700. The processing device 710 can be regarded as a modification of the processing device 510 according to the third embodiment. The processing device 710 is different from the processing device 510 according to the third embodiment in that a supplementary information acquisition unit 715 outputs supplementary information to an examination information acquisition unit 711 and the examination information acquisition unit 711 acquires examination information without an operation of selection from a pathologist. A content determination unit 712, a size determination unit 713, and an image data generation unit 714 are similar to the content determination unit 512, the size determination unit 513, and the image data generation unit 514, respectively. Note that the examination information acquisition unit 711 is similar to the examination information acquisition unit 701 except for outputting the examination information to the content determination unit 712.

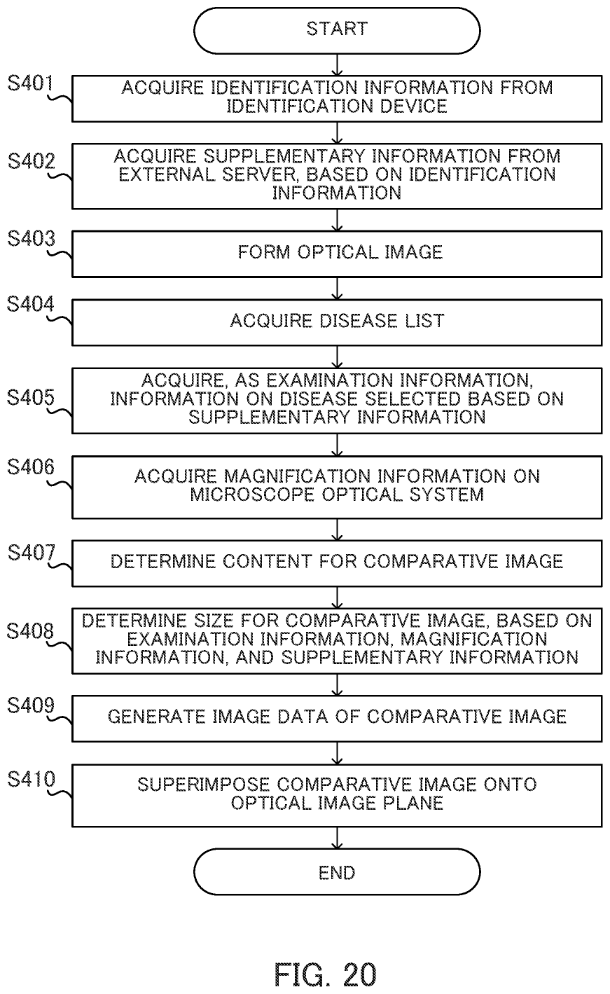

FIG. 20 is a flowchart of exemplary image projection processing that the microscope system according to the present embodiment performs. A specific exemplary image projection method that the microscope system according to the present embodiment performs will be described in detail below with reference to FIG. 20.

The processing in steps S401 to S404 in the image projection processing illustrated in FIG. 20 is similar to the processing in steps S301 to S304 in the image projection processing illustrated in FIG. 17.

In response to acquisition of a disease list, the microscope system outputs, as examination information, disease information selected based on supplementary information (step S405). In this step, the processing device 700 (examination information acquisition unit 701) outputs, as examination information, information on a disease selected, based on the supplementary information acquired in step S402, from the disease list acquired in step S404. The processing in steps S406 to S410 following step S405 is similar to the processing in steps S308 to S312 in the image projection processing illustrated in FIG. 17.

Similarly to the first embodiment, the microscope system and the image projection method according to the present embodiment enable support to pathological diagnosis with visual observation based on an optical image, so that a reduction can be made in the work burden of the pathologist. Similarly to the third embodiment, according to the present embodiment, the pathologist can diagnose with the comparative image, created based on information related to the patient (patient information and sample information), suitable for diagnosis of the patient. Furthermore, according to the present embodiment, the pathologist can omit an operation of selection of a disease to be diagnosed, and thus can start diagnosis immediately.

### Fifth Embodiment

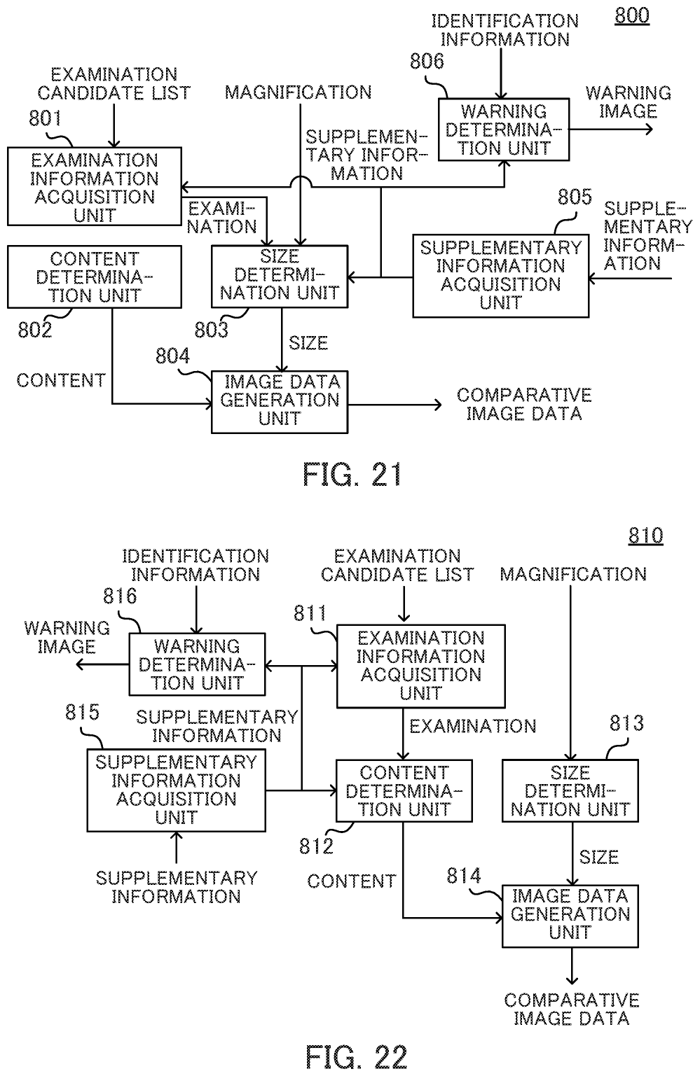

FIG. 21 illustrates an exemplary configuration of a processing device 800. A microscope system according to the present embodiment is different from the microscope system according to the fourth embodiment in terms of including the processing device 800 instead of a processing device 700. As illustrated in FIG. 21, the processing device 800 includes an examination information acquisition unit 801, a content determination unit 802, a size determination unit 803, an image data generation unit 804, a supplementary information acquisition unit 805, and a warning determination unit 806. For example, in response to execution of a program in the processing device 800, an electric circuit included in the processing device 800 operates as the units.

The processing device 800 can be regarded as a modification of the processing device 700 according to the fourth embodiment. The processing device 800 is different from the processing device 700 according to the fourth embodiment in that the warning determination unit 806 is provided, the supplementary information acquisition unit 805 acquires supplementary information without identification information, and the supplementary information acquisition unit 805 outputs the supplementary information to the warning determination unit 806. The examination information acquisition unit 801, the content determination unit 802, the size determination unit 803, and the image data generation unit 804 are similar to the examination information acquisition unit 701, the content determination unit 702, the size determination unit 703, and the image data generation unit 704, respectively.

The supplementary information acquisition unit 805 is similar to the supplementary information acquisition unit 705 in terms of acquiring supplementary information from an external system 10. Note that the supplementary information acquisition unit 805 is different from the supplementary information acquisition unit 705 in that the supplementary information acquisition unit 805 acquires supplementary information automatically distributed from the external system 10, whereas the supplementary information acquisition unit 705 acquires supplementary information, based on identification information.

Based on identification information and the supplementary information, the warning determination unit 806 determines whether or not a sample Si given the identification information is an examination target sample regarding the supplementary information. This is because, in the processing device 800, the supplementary information acquired by the supplementary information acquisition unit 805 is the supplementary information distributed from the external system 10 and there is no corroboration of whether or not the supplementary information is information regarding the sample Si. When determining that the sample Si is not the examination target sample regarding the supplementary information acquired by the supplementary information acquisition unit 805, the warning determination unit 806 outputs a warning image to a projection unit 120.

The microscope system according to the present embodiment may include a processing device 810 illustrated in FIG. 22 instead of the processing device 800. The processing device 810 can be regarded as a modification of the processing device 710 according to the fourth embodiment. The processing device 810 is different from the processing device 710 according to the fourth embodiment in that a warning determination unit 816 is provided, a supplementary information acquisition unit 815 acquires supplementary information without identification information, and the supplementary information acquisition unit 815 outputs the supplementary information to the warning determination unit 816. An examination information acquisition unit 811, a content determination unit 812, a size determination unit 813, and an image data generation unit 814 are similar to the examination information acquisition unit 711, the content determination unit 712, the size determination unit 713, and the image data generation unit 714, respectively.

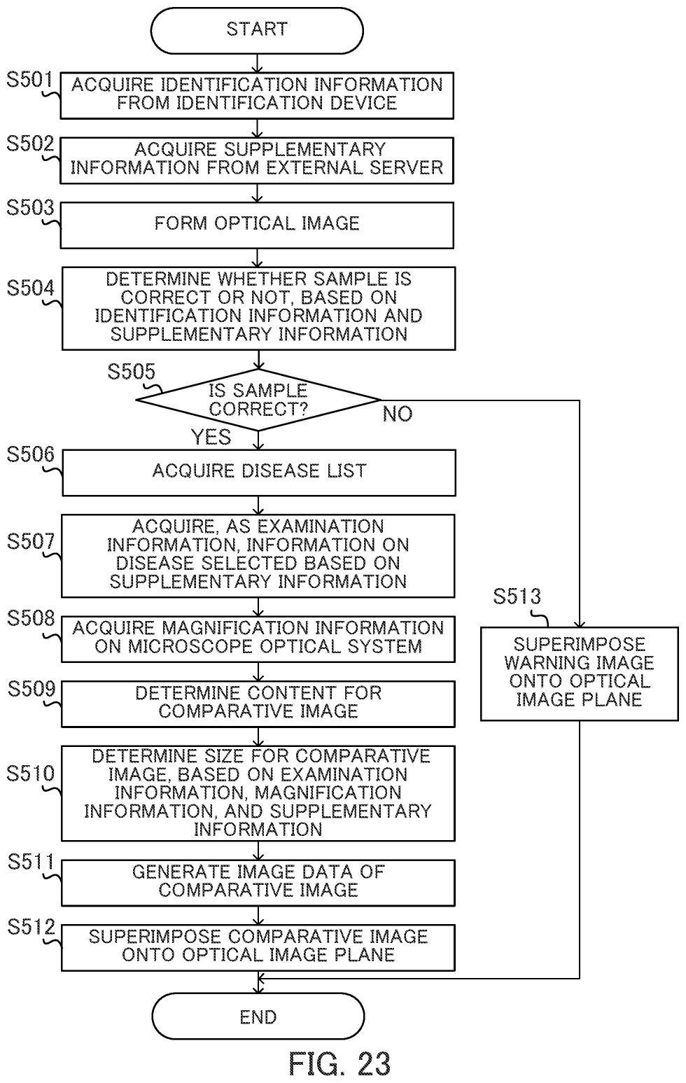

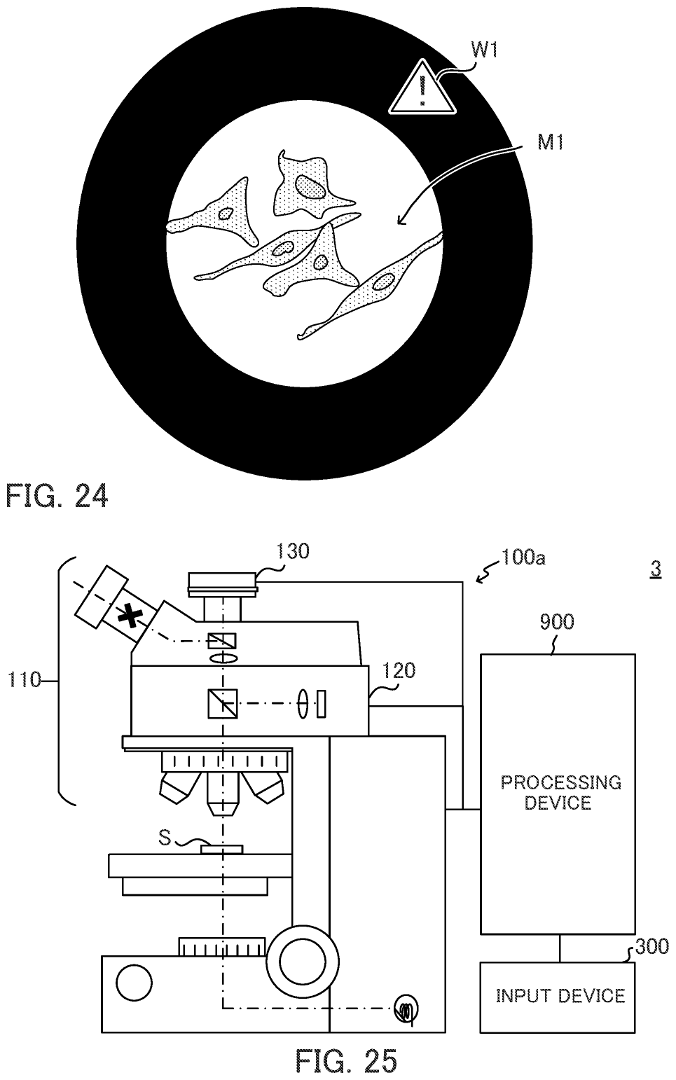

FIG. 23 is a flowchart of exemplary image projection processing that the microscope system according to the present embodiment performs. FIG. 24 illustrates an exemplary image observed through an ocular lens 103 in the microscope system according to the present embodiment. A specific exemplary image projection method that the microscope system according to the present embodiment performs will be described in detail below with reference to FIGS. 23 and 24.

The processing in steps S501 to S503 in the image projection processing illustrated in FIG. 23 is similar to the processing in steps S401 to S403 in the image projection processing illustrated in FIG. 20.

In response to acquisition of identification information and supplementary information, the microscope system determines whether the sample Si is correct or not, based on the identification information and the supplementary information (step S504). In this step, with the identification information given to the sample Si, the processing device 800 (warning determination unit 806) determines whether or not the supplementary information acquired from the external system 10 is information regarding the sample Si.

When it is determined that the sample Si is correct (YES in step S505), the microscope system performs the processing in steps S506 to S512. The processing is similar to the processing in steps S404 to S410 in the image projection processing illustrated in FIG. 20.

Meanwhile, when it is determined that the sample Si is incorrect (NO in step S505), the microscope system superimposes a warning image onto the optical image plane (step S513). In this step, the processing device 800 (warning determination unit 806) generates image data of a warning image and then outputs the image data to the projection unit 120. Based on the image data of the warning image output from the processing device 800, the projection unit 120 projects the warning image onto the optical image plane. Thus, the image illustrated in FIG. 24 is observed through the ocular lens 103.

Referring to FIG. 24, a warning image W1 serves as an image for notifying the pathologist of the possibility that the sample Si is mistaken. Due to the warning image W1, the pathologist can grasp the possibility of sample misidentification. Note that the warning image W1 of a mark indicating warning has been exemplarily given, but the warning image W1 may be an image in which warning content is indicated with character information.

Similarly to the first embodiment, the microscope system and the image projection method according to the present embodiment enable support to pathological diagnosis with visual observation based on an optical image, so that a reduction can be made in the work burden of the pathologist. Similarly to the third embodiment, according to the present embodiment, the pathologist can diagnose with the comparative image, created based on information related to the patient (patient information and sample information), suitable for diagnosis of the patient. Similarly to the fourth embodiment, according to the present embodiment, the pathologist can omit an operation of selection of a disease to be diagnosed, and thus can start diagnosis immediately. Furthermore, according to the present embodiment, automatic verification of whether or not the sample in observation is the sample to be diagnosed enables prevention of sample misidentification.

### Sixth Embodiment

FIG. 25 illustrates an exemplary configuration of a microscope system 3 according to the present embodiment. The microscope system 3 according to the present embodiment is different from the microscope system 1 in that a microscope 100a is provided instead of a microscope 100 and a processing device 900 is provided instead of a processing device 200.

The microscope 100a is different from the microscope 100 in that an image capturing device 130 is provided, a trinocular barrel is provided as an ocular barrel, and the image capturing device 130 is attached to the ocular barrel. The image capturing device 130 captures an image of a sample S and then outputs image data of the sample image to the processing device 900.

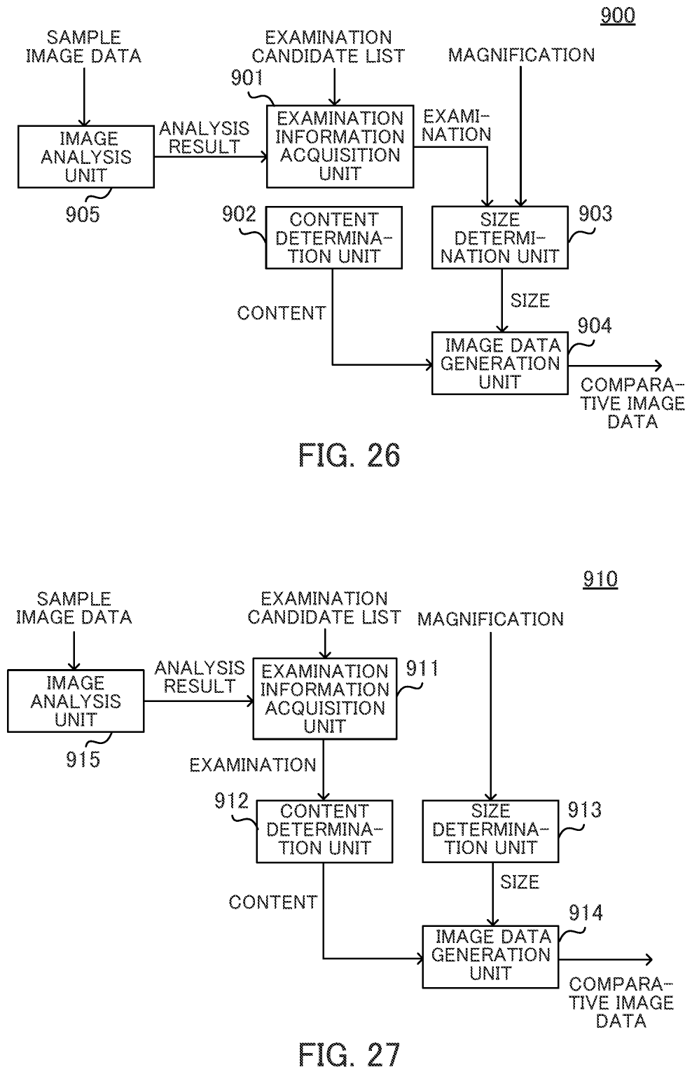

FIG. 26 illustrates an exemplary configuration of the processing device 900. The processing device 900 includes an examination information acquisition unit 901, a content determination unit 902, a size determination unit 903, an image data generation unit 904, and an image analysis unit 905. For example, in response to execution of a program in the processing device 900, an electric circuit included in the processing device 900 operates as the units.

The processing device 900 is different from the processing device 200 according to the first embodiment in that the image analysis unit 905 is provided and the examination information acquisition unit 901 acquires examination information without an operation of selection from a pathologist. The content determination unit 902, the size determination unit 903, and the image data generation unit 904 are similar to the content determination unit 202, the size determination unit 203, the image data generation unit 204, respectively.

The image analysis unit 905 analyzes the image data of the sample image acquired from the image capturing device 130 and then outputs an analysis result to the examination information acquisition unit 901. Analysis in the image analysis unit 905 is, but is not particularly limited to, for example, image classification with a trained model acquired by deep learning. The image analysis unit 905 classifies the sample S shown in the sample image and then outputs a classification result as an analysis result to the examination information acquisition unit 901.

The examination information acquisition unit 901 acquires examination information. The examination information acquisition unit 901 acquires, as examination information, information on an examination candidate selected, based on the analysis result output from the image analysis unit 905, from a plurality of examination candidates included in an examination candidate list, and then outputs the information to the size determination unit 903. That is, the processing device 900 acquires, as examination information, the information on the examination candidate selected based on the image data of the sample image.

The microscope system according to the present embodiment may include a processing device 910 illustrated in FIG. 27 instead of the processing device 900. The processing device 910 is different from the processing device 400 according to the second embodiment in that an image analysis unit 915 is provided and an examination information acquisition unit 911 acquires examination information without an operation of selection from a pathologist. A content determination unit 912, a size determination unit 913, and an image data generation unit 914 are similar to the content determination unit 412, the size determination unit 413, and the image data generation unit 414, respectively.

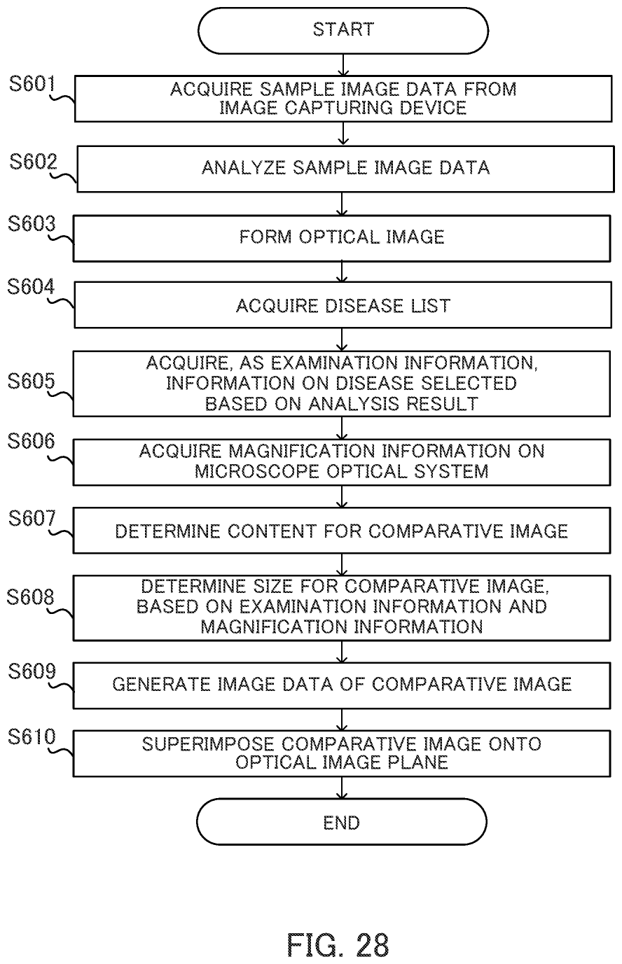

FIG. 28 is a flowchart of exemplary image projection processing that the microscope system according to the present embodiment performs. A specific exemplary image projection method that the microscope system according to the present embodiment performs will be described in detail below with reference to FIG. 28.

In response to starting of the image projection processing illustrated in FIG. 28, in the microscope system according to the present embodiment, the processing device 900 acquires image data of a sample image from the image capturing device 130 (step S601) and analyzes the acquired image data of the sample image to generate an analysis result (step S602). The processing in steps S603 and S604 following step S602 is similar to the processing in steps S101 and S102 in the image projection processing illustrated in FIG. 5.

In response to acquisition of the analysis result and a disease list, the microscope system acquires, as examination information, information on a disease selected based on the analysis result (step S605). In this step, the processing device 900 (examination information acquisition unit 901) acquires, as examination information, information on an examination candidate selected, based on the analysis result, from a plurality of pieces of examination information included in the disease list. For example, in a case where the analysis result indicates that the sample S is tissue extracted from the large bowel, the processing device 900 may select, as examination information, for example, large bowel cancer from a plurality of diseases.

The processing in steps S606 to S610 following step S605 is similar to the processing in steps S106 to S110 in the image projection processing illustrated in FIG. 5.

Similarly to the first embodiment, the microscope system and the image projection method according to the present embodiment enable support to pathological diagnosis with visual observation based on an optical image, so that a reduction can be made in the work burden of the pathologist. Furthermore, similarly to the fifth embodiment, according to the present embodiment, the pathologist can omit an operation of selection of a disease to be diagnosed, and thus can start diagnosis immediately.

### Seventh Embodiment

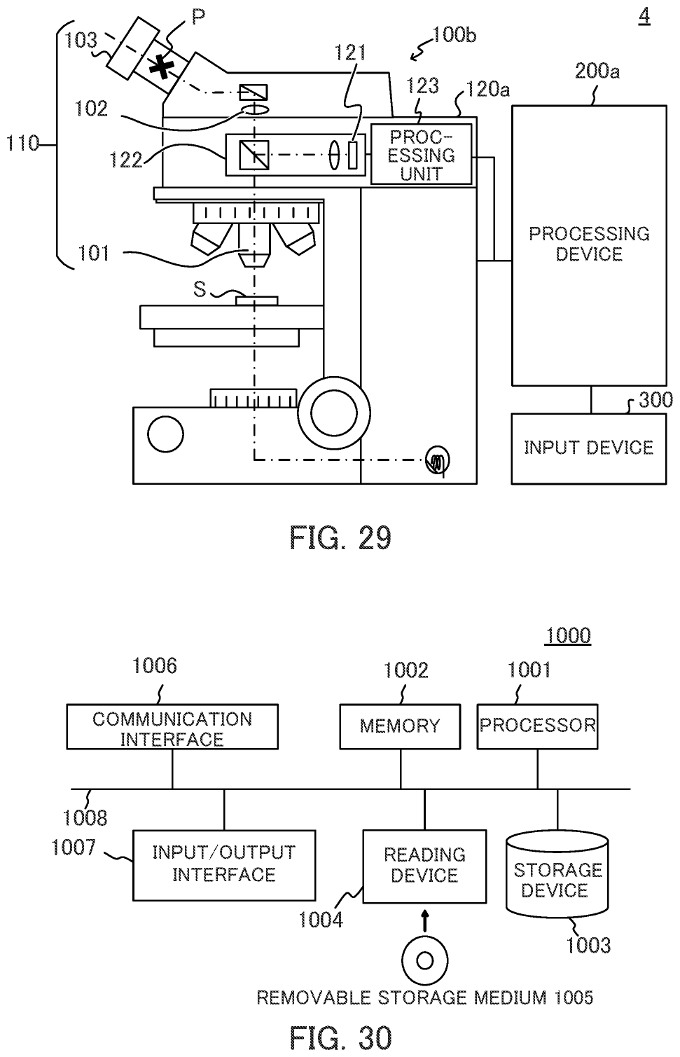

FIG. 29 illustrates an exemplary configuration of a microscope system 4 according to the present embodiment. The microscope system 4 according to the present embodiment is different from the microscope system 1 in that a microscope 100b is provided instead of a microscope 100 and a processing device 200a is provided instead of a processing device 200.

The microscope 100b is different from the microscope 100 in that a projection unit 120a is provided instead of a projection unit 120. The projection unit 120a serves as a projection unit for a microscope system, and is different from the projection unit 120 in that a processing unit 123 is provided in addition to a projector 122 corresponding to the projection unit 120. The projector 122 is an exemplary superimposition unit that projects a comparative image onto the image plane.

The processing unit 123 has a configuration similar to the configuration of the processing device 200 illustrated in FIG. 4. That is, the processing unit 123 performs processing like the examination information acquisition unit 201, the content determination unit 202, the size determination unit 203, and the image data generation unit 204. Meanwhile, the processing device 200a is similar to the processing device 200 in terms of serving as a control box for a microscope device, but is different from the processing device 200 in terms of not being involved in projection control of the projection unit 120.

Similarly to the first embodiment, the microscope system and the image projection method according to the present embodiment enable support to pathological diagnosis with visual observation based on an optical image, so that a reduction can be made in the work burden of the pathologist. Furthermore, according to the present embodiment, attachment of the projection unit 120a to an existing microscope system enables image projection processing similar to that of the microscope system 1.

Above given has been the example in which the processing unit 123 has all the functional configuration of the processing device 200 illustrated in FIG. 4. However, the processing unit 123 may have part of the functional configuration of the processing device 200 illustrated in FIG. 4 and the processing device 200a may have the remaining configuration. Above given has been the example in which the processing unit 123 has the entirety or part of the functional configuration of the processing device 200 illustrated in FIG. 4. However, the processing unit 123 may have the entirety or part of the functional configuration of the processing device according to any of the embodiments. For example, the processing unit 123 may have the entirety or part of the functional configuration of the processing device 400 illustrated in FIG. 11.

FIG. 30 illustrates an exemplary hardware configuration of a computer 1000 for achievement of each processing device or the projection unit 120a described above. The hardware configuration illustrated in FIG. 30 includes, for example, a processor 1001, a memory 1002, a storage device 1003, a reading device 1004, a communication interface 1006, and an input/output interface 1007. Note that the processor 1001, the memory 1002, the storage device 1003, the reading device 1004, the communication interface 1006, and the input/output interface 1007 are mutually connected, for example, through a bus 1008.

The processor 1001 may be, for example, a single processor, a multiprocessor, or a multi-core processor. The processor 1001 reads and executes a program stored in the storage device 1003, to operate as such an examination information acquisition unit, a content determination unit, a size determination unit, an image data generation unit, a supplementary information acquisition unit, a warning determination unit, or an image analysis unit as described above.

The memory 1002 is, for example, a semiconductor memory and may include a RAM area and a ROM area. The storage device 1003 is, for example, a hard disk, a semiconductor memory, such as a flash memory, or an external storage device.

For example, the reading device 1004 accesses a storage medium 1005, in accordance with an instruction from the processor 1001. For example, the storage medium 1005 is achieved by a semiconductor device, a medium to or from which information is input or output due to a magnetic effect, or a medium to or from which information is input or output due to an optical effect. Note that such a semiconductor device is, for example, a universal serial bus (USB) memory. Such a medium to or from which information is input or output due to a magnetic effect is, for example, a magnetic disk. Such a medium to or from which information is input or output due to an optical effect is, for example, a compact disc (CD)-ROM, a digital versatile disc (DVD), or a Blu-ray disc (Blu-ray is a registered trademark).

For example, the communication interface 1006 communicates with a different device, in accordance with an instruction from the processor 1001. The input/output interface 1007 is, for example, an interface between an input device and an output device. The input device may include the input device 300 and the identification device 600. For example, the input device may be a device, such as a keyboard, a mouse, or a touch panel, that receives an instruction from a user. The output device is, for example, a display device, such as a display, or a sound device, such as a speaker.

For example, the program that the processor 1001 executes is provided to the computer 1000 in the following forms:
(1) Pre-installation on the storage device 1003
(2) Provision from the storage medium 1005
(3) Provision from a server, such as a program server.

Note that the hardware configuration of the computer 1000 for achievement of each processing device and the projection unit described with reference to FIG. 30 is just exemplary and thus embodiments are not limited to this. For example, part of the configuration described above may be omitted or a new configuration may be added to the configuration described above. In another embodiment, for example, the entirety or part of the function of any of the electric circuits described above may be implemented as hardware based on a field programmable gate array (FPGA), a system-on-a-chip (SoC), an application specific integrated circuit (ASIC) or a programmable logic device (PLD).

The embodiments described above are specific examples for facilitating understanding of the invention, and thus the present invention is not limited to the embodiments. Modifications of the embodiments described above and alternatives to the embodiments described above are to be included. That is, the constituent elements in each embodiment can be modified without departing from the spirit and scope of the invention. Appropriate combination of a plurality of constituent elements disclosed in one or more of the embodiments enables a new embodiment. Some constituent elements may be omitted from the constituent elements in each embodiment, or some constituent elements may be added to the constituent elements in each embodiment. Furthermore, the procedure of processing in each embodiment may be changed in order as long as there is no contradiction. That is, the microscope system, the projection unit, and the image projection method according to the present invention can be variously modified or altered without departing from the scope of the claims.

In each embodiment described above, the projection unit is exemplified as an exemplary superimposition device. However, the microscope system may include, as a superimposition device, a display device including a transmissive liquid crystal element disposed on the optical path between the objective lens 101 and the ocular lens 103. The transmissive liquid crystal element may be disposed at the image plane on which an optical image is formed. An image displayed by the transmissive liquid crystal element may be superimposed directly onto the optical image.

Above exemplified is the infiltration distance related to the depth of invasion as an exemplary length that is a criterion for judgment in diagnosis (criterial length). However, the criterial length is not limited to the depth of invasion and thus may be length related to the degree of invasion or the degree of differentiation. Above given has been the example in which a comparative image is generated with emphasis on size including length. However, a comparative image may have emphasis on shape rather than size. The microscope system may give discovery support for an atypical cell with a comparative image having emphasis on shape, leading to support in diagnosis.

In the present specification, the expression “based on A” does not indicate “based on only A” but indicates “based on at least A” and further indicates “based partially on at least A”. That is, “based on A” may be “based on B in addition to A” or “based on part of A”.

What is claimed is:

1. A microscope system comprising:
a microscope optical system including an ocular lens, the microscope optical system being configured to form an optical image of a sample on an object side of the ocular lens;
a processor configured to generate, based on examination information regarding examination to the sample and magnification information regarding a magnification of the microscope optical system, image data of a comparative image for comparison with the optical image; and
a superimposition device configured to superimpose, based on the image data generated by the processor, the comparative image onto an image plane on which the optical image is formed.

2. The microscope system according to claim 1, wherein
the examination information includes disease information specifying a disease to be diagnosed in pathological diagnosis with the sample,
content for the comparative image includes an indicator indicating a size of a noticed part related to the disease, and
the processor determines a size for the comparative image, based on the disease information and the magnification information.

3. The microscope system according to claim 1, wherein
the examination information includes:
disease information specifying a disease to be diagnosed in pathological diagnosis with the sample; and
progression information specifying a progression of the disease,
content for the comparative image includes an indicator indicating a size of a noticed part related to the disease, and
the processor determines a size for the comparative image, based on the disease information, the progression information, and the magnification information.

4. The microscope system according to claim 1, wherein
the examination information includes disease information specifying a disease to be diagnosed in pathological diagnosis with the sample,
content for the comparative image includes an image of a noticed part related to the disease, and
the processor
determines the content for the comparative image, based on the disease information, and
determines a size for the comparative image, based on the magnification information.

5. The microscope system according to claim 1, wherein
the examination information includes:
disease information specifying a disease to be diagnosed in pathological diagnosis with the sample; and
progression information specifying a progression of the disease,
content for the comparative image includes an image of a noticed part related to the disease, and
the processor
determines the content for the comparative image, based on the disease information and the progression information, and
determines a size for the comparative image, based on the magnification information.

6. The microscope system according to claim 1, further comprising:
an identification information reader configured to read identification information given to a container of the sample, wherein
the processor
acquires, based on the identification information read by the identification information reader, from an external system, supplementary information including at least either sample information regarding the sample or patient information regarding a patient from which the sample has been extracted, and
generates the image data, based on the examination information, the magnification information, and the supplementary information.

7. The microscope system according to claim 2, further comprising:
an identification information reader configured to read identification information given to a container of the sample, wherein
the processor
acquires, based on the identification information read by the identification information reader, from an external system, supplementary information including at least either sample information regarding the sample or patient information regarding a patient from which the sample has been extracted, and
generates the image data, based on the examination information, the magnification information, and the supplementary information.

8. The microscope system according to claim 3, further comprising:
an identification information reader configured to read identification information given to a container of the sample, wherein
the processor
acquires, based on the identification information read by the identification information reader, from an external system, supplementary information including at least either sample information regarding the sample or patient information regarding a patient from which the sample has been extracted, and
generates the image data, based on the examination information, the magnification information, and the supplementary information.

9. The microscope system according to claim 4, further comprising:
an identification information reader configured to read identification information given to a container of the sample, wherein
the processor
acquires, based on the identification information read by the identification information reader, from an external system, supplementary information including at least either sample information regarding the sample or patient information regarding a patient from which the sample has been extracted, and
generates the image data, based on the examination information, the magnification information, and the supplementary information.

10. The microscope system according to claim 5, further comprising:
an identification information reader configured to read identification information given to a container of the sample, wherein
the processor
acquires, based on the identification information read by the identification information reader, from an external system, supplementary information including at least either sample information regarding the sample or patient information regarding a patient from which the sample has been extracted, and
generates the image data, based on the examination information, the magnification information, and the supplementary information.

11. The microscope system according to claim 6, wherein
the processor acquires, as the examination information, information on an examination candidate selected, based on the supplementary information, from a plurality of examination candidates.

12. The microscope system according to claim 1, wherein
the processor acquires, as the examination information, information on an examination candidate selected, in response to an operation from a user, from a plurality of examination candidates, and
the superimposition device
superimposes the plurality of examination candidates onto the image plane before acquiring the examination information, and
superimposes the comparative image onto the image plane after acquiring the examination information.

13. The microscope system according to claim 2, wherein
the processor acquires, as the examination information, information on an examination candidate selected, in response to an operation from a user, from a plurality of examination candidates, and
the superimposition device
superimposes the plurality of examination candidates onto the image plane before acquiring the examination information, and
superimposes the comparative image onto the image plane after acquiring the examination information.

14. The microscope system according to claim 3, wherein
the processor acquires, as the examination information, information on an examination candidate selected, in response to an operation from a user, from a plurality of examination candidates, and
the superimposition device
superimposes the plurality of examination candidates onto the image plane before acquiring the examination information, and
superimposes the comparative image onto the image plane after acquiring the examination information.

15. The microscope system according to claim 4, wherein
the processor acquires, as the examination information, information on an examination candidate selected, in response to an operation from a user, from a plurality of examination candidates, and
the superimposition device
superimposes the plurality of examination candidates onto the image plane before acquiring the examination information, and
superimposes the comparative image onto the image plane after acquiring the examination information.

16. The microscope system according to claim 1, further comprising:
an image capturing device configured to capture an image of the sample, wherein
the processor acquires, as the examination information, information on an examination candidate selected, based on image data of a sample image generated by the image capturing device, from a plurality of examination candidates.

17. The microscope system according to claim 1, further comprising:
an identification information reader configured to read identification information given to a container of the sample, wherein
the processor determines, based on the identification information read by the identification information reader and supplementary information that is acquired from an external system and includes at least either sample information regarding an examination target sample or patient information regarding a patient from which the examination target sample has been extracted, whether or not the sample is the examination target sample, and
the superimposition device superimposes a warning image onto the image plane when the processor determines that the sample is not the examination target sample.

18. The microscope system according to claim 1, wherein
the sample is sandwiched between a slide glass and a cover glass.

19. A projection unit for a microscope system including a microscope optical system, the projection unit comprising:
a processor configured to generate, based on examination information regarding examination to a sample and magnification information regarding a magnification of the microscope optical system, image data of a comparative image for comparison with an optical image formed on an object side of an ocular lens included in the microscope optical system; and
a superimposition unit configured to superimpose, based on the image data generated by the processor, the comparative image onto an image plane on which the optical image is formed.

20. An image projection method to be performed by a microscope system including a microscope optical system, the image projection method comprising:
forming an optical image of a sample on an object side of an ocular lens included in the microscope optical system;
generating, based on examination information regarding examination to the sample and magnification information regarding a magnification of the microscope optical system, image data of a comparative image for comparison with the optical image; and
superimposing, based on the image data generated, the comparative image onto an image plane on which the optical image is formed.
